(19) United States
(12) Patent Application Publication
(10) Pub. No.: US 2013/0207751 A1
(43) Pub. Date: Aug. 15, 2013

(54) MAGNETIC ACTUATOR WITH TWO-PIECE SIDE PLATES FOR A CIRCUIT BREAKER

(71) Applicant: ABB TECHNOLOGY AG, (US)

(72) Inventor: Christian REUBER, Willich (DE)

(73) Assignee: ABB TECHNOLOGY AG, Zurich (CH)

(21) Appl. No.: 13/851,588

(22) Filed: Mar. 27, 2013

Related U.S. Application Data
(63) Continuation of application No. PCT/EP2011/004829, filed on Sep. 27, 2011.

(30) Foreign Application Priority Data
Sep. 27, 2010 (EP) 10010812.5

(51) Int. Cl. H01H 36/00

(52) U.S. Cl. CPC H01H 36/00
USPC 335/179; 29/602.1

(57) ABSTRACT

A magnetic actuator unit is provided for a circuit breaker arrangement, such as a medium voltage vacuum circuit breaker. The magnetic actuator unit includes a coil, a core, and a movable plate. The core accommodates the coil, and has a core element which is arranged between permanent magnets and flanks of the core. The movable plate is attracted by the core due to the magnetic field of the permanent magnets and the coil. The movable plate is actuating the circuit breaker arrangement when it is attracted by the core. The magnetic actuator unit includes a first attachment element for attaching the magnetic actuator unit to a member of the circuit breaker arrangement. The first attachment element is attached to the flanks and not to the core element of the core.

### RELATED APPLICATIONS

This application claims priority as a continuation application under 35 U.S.C. §120 to PCT/EP2011/004829, which was filed as an International Application on Sep. 27, 2011 designating the U.S., and which claims priority to European Application 10010812.5 filed in Europe on Sep. 27, 2010. The entire contents of these applications are hereby incorporated by reference in their entireties.

### FIELD

The present disclosure relates to a magnetic actuator unit for a circuit breaker arrangement, a method of assembling a magnetic actuator unit, the use of a magnetic actuator unit, and a circuit breaker arrangement.

### BACKGROUND INFORMATION

For the operation of a circuit breaker, such as a medium voltage vacuum circuit breaker, it can be necessary to generate a high force to press the first moving electrical contact to a second corresponding fixed electrical contact. The force can be generated by a magnetic actuator unit. The magnetic actuator unit includes a coil for generating an electrical field, a core for forming this field, and a movable plate which is attracted by the core. When being attracted by the core, the movable plate generates the force used for actuating the circuit breaker.

EP 1 843 375 A1 discloses an electro-magnetic actuator for a medium-voltage switch, having a first movable plate in the form of a round yoke, an actuating shaft, and a lower, smaller second movable plate in the form of a lower smaller yoke, which is fixedly spaced apart from the first movable plate and arranged at an opposite end of the core.

U.S. 2008/0272 659 A1 discloses an electro-magnetic force driving actuator and a circuit breaker using the same.

For fixing such an actuator to a circuit breaker, a stainless steel plate can be attached to the core element of the actuator.

### SUMMARY

An exemplary embodiment of the present disclosure provides a magnetic actuator unit for a circuit breaker arrangement. The exemplary magnetic actuator unit includes a coil, and a core for accommodating the coil. The core has permanent magnets, flanks, and a core element which is arranged between the permanent magnets and the flanks of the core. The exemplary magnetic actuator unit also includes a movable plate configured to be attracted by the core due to a magnetic field generated by the permanent magnets and the coil. The movable plate is configured to actuate the circuit breaker arrangement when being attracted by the core. In addition, the exemplary magnetic actuator unit includes one or more first attachment elements configured to attach the magnetic actuator unit to a member of the circuit breaker arrangement. The one or more first attachment elements are attached to the flanks and not to the core element of the core.

An exemplary embodiment of the present disclosure provides a method of assembling a magnetic actuator unit for a circuit breaker arrangement. The exemplary method includes putting a coil into a groove of a core of the magnetic actuator unit, such that a section of the coil is accommodated in the groove. The exemplary method also includes attaching a second attachment element to flanks of the core, and attaching a first attachment element for attaching the magnetic actuator unit to a member of the circuit breaker arrangement to the flanks of the core.

### BRIEF DESCRIPTION OF THE DRAWINGS

Additional refinements, advantages and features of the present disclosure are described in more detail below with reference to exemplary embodiments illustrated in the drawings.

FIG. 1 shows a perspective view of a magnetic actuator unit according to an exemplary embodiment of the present disclosure.

FIG. 2 shows a perspective view of a magnetic actuator unit according to an exemplary embodiment of the present disclosure.

FIG. 3 shows a perspective view of a magnetic actuator unit according to an exemplary embodiment of the present disclosure.

FIG. 4 shows a perspective view of a magnetic actuator unit according to an exemplary embodiment of the present disclosure.

FIG. 5 shows a schematic drawing of a circuit breaker arrangement according to an exemplary embodiment of the present disclosure.

FIG. 6 shows a flow diagram of a method of assembling a magnetic actuator unit according to an exemplary embodiment of the present disclosure.

The reference symbols used in the drawings, and their meanings, are listed in summary form in the list of reference symbols. In principle, identical or similarly functioning parts are provided with the same reference symbols in the drawings.

### DETAILED DESCRIPTION

Exemplary embodiments of the present disclosure provide an alternative fixing of the actuator.

An exemplary embodiment of the present disclosure provides a magnetic actuator unit for a circuit breaker arrangement. The magnetic actuator unit includes a coil, and a core for accommodating the coil. The core has a core element which is arranged between permanent magnets and flanks of the core. A movable plate is attracted by the core when a magnetic field is generated by the coil. The movable plate actuates the circuit breaker arrangement when being attracted by the core. This can mean that electrical contacts of the circuit breaker are opened or closed, when it is actuated. The magnetic actuator unit also includes a first attachment element for attaching the magnetic actuator unit to a member of the circuit breaker arrangement. The first attachment element is attached to the flanks and not to the core element of the core.

Such a magnetic actuator unit with a first attachment element attached to the flanks and not to the core element of the core can enable and reduction in the cost of the magnetic actuator, since the first attachment element can be made of regular steel and does not have to be made of non-magnetic material such as stainless steel. The additional magnetic stray flux due to the first attachment element can result in only a negligible reduction of the locking force, such that it can be tolerated in most applications. A magnetic short circuit for the permanent magnets by the first attachment means can be avoided.

In other words, an exemplary embodiment of the present disclosure proposes to use two side plates, meaning a first attachment element for attaching the magnetic actuator unit to a member of the circuit breaker arrangement being attached at the flanks of the core, and a second attachment element for fixing the core element to the flanks of the core. The second attachment element can be made of non-magnetic material such as stainless steel, for example, in order to avoid a magnetic short circuit for permanent magnets which can be arranged between the core element and the flanks of the core, thus not reducing the locking force. The first attachment element can be made of regular steel, for example, which reduces the costs compared to an embodiment in which only one attachment element is used for fixing the core element to the flanks and for attaching the magnetic actuator unit to a member of the circuit breaker arrangement, which would have to be made of non-magnetic material such as stainless steel in order to avoid a magnetic short circuit for the permanent magnets. Stainless steel is relatively costly compared to regular steel.

In accordance with an exemplary embodiment, the magnetic actuator unit can also include a fixing arrangement or a fixing device for fixing the first attachment element to the flanks. The fixing arrangement can include at least one screw.

According to an exemplary embodiment of the present disclosure, the first attachment element is U-shaped and attached to the flanks at leg parts of the U-shaped first attachment element. Thus, material between the two leg parts of the U-shaped first attachment element can be omitted and material and costs can be reduced.

According to an exemplary embodiment of the present disclosure, the first attachment element is attached to the member of the circuit breaker arrangement at a base part connecting the leg parts of the U-shaped first attachment elements, thereby providing sufficient strength for the first attachment element to fix or support the magnetic actuator unit with respect to the circuit breaker arrangement.

According to an exemplary embodiment of the present disclosure, the base part of the U-shaped first attachment element includes a flange part extending away from the coil in a direction orthogonal to the base part. The flange part can be used to attach the first attachment element at fixing points to a circuit breaker arrangement or to a member of the circuit breaker arrangement.

According to an exemplary embodiment of the present disclosure, the first attachment element is made of a plate-like material. The thickness of the plate-like material can be adapted to provide enough strength for the first attachment element and to save as much material as possible at the same time. The first attachment element can be made of regular steel or any material providing the required strength for the first attachment element to attach or fix the magnetic actuator unit to a circuit breaker arrangement.

According to an exemplary embodiment of the present disclosure, the magnetic actuator unit includes a second attachment element attached to the flanks of the core for stabilizing the core. The second attachment element can be attached to the flanks and to the core element for stabilizing the core. The second attachment element can be non-magnetic to avoid a magnetic short circuit for the permanent magnets arranged between the core element and the flanks, such that the locking force of the magnetic actuator unit can be maintained and not reduced. The second attachment element can include stainless steel, for example.

An exemplary embodiment of the present disclosure provides a method of assembling or manufacturing a magnetic actuator unit for a circuit breaker arrangement.

According to an exemplary embodiment of the present disclosure, the method includes the steps of putting a coil into a groove of a core of the magnetic actuator, such that a section of the coil is accommodated in the groove, attaching a second attachment element to flanks of the core, and attaching a first attachment element for attaching the magnetic actuator unit to a member of the circuit breaker arrangement to the flanks and not the core element of the core.

It is to be understood that features of the method as described in the above and the following can be features of the magnetic actuator unit as described in the above and in the following and vice-versa.

An exemplary embodiment of the present disclosure provides for the use of a magnetic actuator unit as described in the above and in the following in a medium voltage vacuum circuit breaker. A medium voltage can be a voltage between 1 kV and 72 kV.

An exemplary embodiment of the present disclosure provides a circuit breaker arrangement.

According to an exemplary embodiment of the present disclosure, the circuit breaker arrangement includes at least one magnetic actuator unit as described in the above and in the following. The circuit breaker arrangement includes a first electrical contact, and a second electrical contact. The magnetic actuator can be mechanically connected to the first and second contacts, such that the movable plate actuates the circuit breaker by connecting or disconnecting the first and second contacts when moving.

These and other aspects and advantages of the present disclosure will be apparent from and elucidated with reference to the exemplary embodiments described hereinafter.

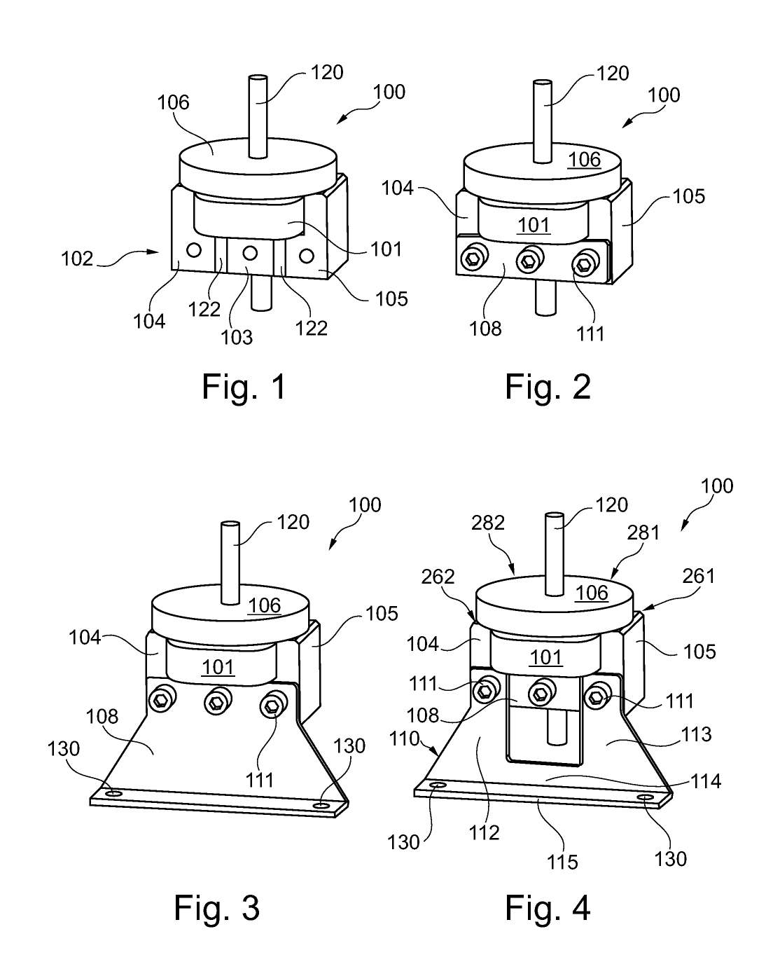

FIG. 1 shows a perspective view of an (electro-) magnetic actuator unit 100 according to an exemplary embodiment of the present disclosure. The magnetic actuator unit 100 includes an electromagnet with a coil 101 and a core 102. The core 102 of the magnetic actuator unit 100 includes a core element or central part 103, two permanent magnets 122, and two flanks 104 and 105. The lower part of the first flank 104, the first permanent magnet 122, the lower part of the core element 103, the second permanent magnet 122, and the lower part of the second flank 105 form a beam, such that the core 102 has a comb-like structure.

Between the fingers of the comb (e.g., the upper parts of the core element 103 and the flanks 104 (105)), two grooves are formed. The first (second) groove is limited by the inner side of the upper part of the flank 104 (105) and a side of the upper part of the core element 103 facing the side of the flank 104 (105).

In the first and second grooves, a first section and a second section of the coil 101 is accommodated. Other sections of the coil 101 protrude over the sides of the core in a direction orthogonal to the extension of the beam.

An axis 120 for guiding a movable plate 106 extends to a hole in the core element 103 of the core 102. Due to the axis 120, the movable plate 106 can only move towards the core 102 and away from the core 102. From the permanent magnets 122 and from the coil 101, when an electrical currents runs through it, a magnetic field is generated in the core 102 which will attract the moving plate 106. The moving plate 106 can be moved back into the opening position by a spring, for example.

FIG. 2 shows an exemplary embodiment of a magnetic actuator unit 100 which differs from the magnetic actuator unit 100 of FIG. 1 in that the core element and the flanks 104, 105 are fixed, such that their upper ends have a good alignment with the movable plate 106 to achieve an optimal locking force of the actuator unit 100. A bar or second attachment element 108 is fixed with screws 111 to the core element and to the flanks 104, 105. The bar 108 is made of a non-magnetic material, such as stainless steel, for example, in order to avoid a magnetic short circuit for the permanent magnets between the flanks 104, 105 and the core element (see FIG. 1), which would result in a reduced locking force of the magnetic actuator unit 100.

At the back side of the core 102, which is not visible in FIG. 2, another bar or second attachment element 108 can be installed to increase the mechanical integrity of the core 102.

FIG. 3 shows an exemplary embodiment of the magnetic actuator of FIG. 2, with the difference that the bar 108 includes a dedicated extension to reach fixing points 130 to attach or fix the magnetic actuator unit to a member of a circuit breaker arrangement or to a circuit breaker arrangement. Depending on the required fixing points 130 to fix the bar 108 to the circuit breaker, the extended bar can be a relatively large part. As the extended bar 108 will be made of non-magnetic material like stainless steel, it will be relatively costly.

At the back side of the core 102, which is not shown FIG. 3, another bar or second attachment element 108 can be installed to increase the mechanical integrity of the core 102.

FIG. 4 shows a perspective view of a magnetic actuator unit 100 according to an exemplary embodiment of the present disclosure which includes the magnetic actuator unit 100 of FIG. 1. Two grooves 261, 262 are formed between the fingers of the core 102, the core 102 having a comb-like structure. The first (second) groove 261 (262) is limited by the inner side of the upper part of the flank 105 (104) at a side of the upper part of the core element (see FIG. 1) facing the side of the flank 105 (104). In the first and second grooves 261, 262, a first and second section 281, 282 of the coil 101 is accommodated. A second attachment element 108 or bar is attached by screws 111 directly to the core parts, such as the flanks 104, 105 and the core element of the magnetic actuator unit 100 for stabilizing or fixing the core such that the upper ends of the flanks 104, 105 have a good alignment with the movable plate 106 to achieve an optimal locking force of the magnetic actuator unit 100.

A first attachment element 110 or extension plate for attaching the magnetic actuator unit 100 to a member of the circuit breaker arrangement is screwed only onto the flanks 104 and 105 and not onto the core element 103 by fixing elements 111 such as screws, for example. Consequently, the first attachment element 110 can be made of or can include regular steel, whereas the second attachment element 108 is made of a non-magnetic material such as stainless steel in order to avoid a magnetic short circuit for the permanent magnets being arranged between the core element and the flanks 104, 105. A reduced locking force due to such a magnetic short circuit can thus be avoided.

At the back side of the core 102, which is not shown FIG. 4, another bar or second attachment element 108 and another first attachment element 110 can be installed to increase the mechanical integrity of the core 102 and to improve the attachment of the magnetic actuator unit 100 to a member of the circuit breaker arrangement.

In accordance with an exemplary embodiment, the first attachment element 110 is U-shaped and attached to the flanks 104, 105 at leg parts 112, 113 of the U-shaped first attachment element 110. The first attachment element 110 is attached to the member of the circuit breaker arrangement at a base part 114 connecting the leg parts 112, 113, wherein the base part 114 includes a flange part 115 extending away from the coil 101 in a direction orthogonal to the base part 114 and includes two fixing points 130 in the form of through holes configured to fix the first attachment element 110 to a member of the circuit breaker arrangement.

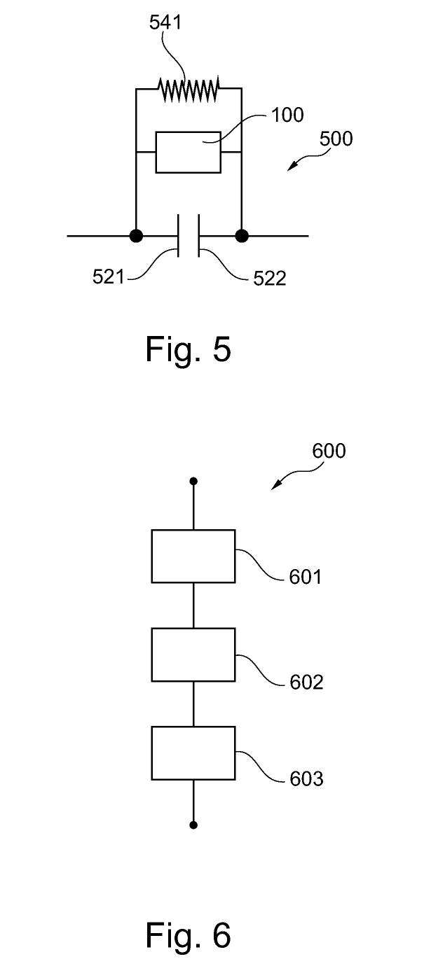

FIG. 5 shows a schematic drawing of a circuit breaker arrangement 500 according to an exemplary embodiment of the present disclosure. The circuit breaker arrangement 500 includes two electrical contacts 521, 522 that can be electrically connected to lines of a medium voltage grid. Further, the electrical contacts 521, 522 can be arranged inside a vacuum. Accordingly, the circuit breaker 500 can be a medium voltage vacuum circuit breaker.

The circuit breaker 500 includes a magnetic actuator 100 that is mechanically connected to the contacts 521, 522, such that the movable plate actuates the circuit breaker 500 by connecting or disconnecting the contacts 521, 522, when moving. The circuit breaker 500 can also include a spring 541 for generating a force opposite to the movement of the movable plate generated by the activated magnetic field of the magnetic actuator.

FIG. 6 shows a schematic flow diagram for a method of assembling the magnetic actuator unit of FIG. 4 according to an exemplary embodiment of the present disclosure. In step 601, the coil 101 is put into the grooves 261, 262 of the core 102 of the magnetic actuator unit 100, such that a section 281, 282 of the coil 101 is accommodated in the grooves 261, 262.

In step 602, a second attachment element 108 is attached to a core element 103 and to flanks 104, 105 of the core 102.

In step 603, a first attachment element 110 for attaching the magnetic actuator unit 100 to a member of the circuit breaker arrangement 500 is attached to the flanks 104, 105 and not to the core element 103 of the core 102.

While the present disclosure has been illustrated and described in detail in the drawings and foregoing description, such illustration and description are to be considered illustrative or exemplary and not restrictive; the disclosure is not limited to the disclosed exemplary embodiments. Other variations to the disclosed exemplary embodiments can be understood and effected by those skilled in the art in practicing the claimed disclosure, from a study of the drawings, the disclosure, and the appended claims. In the claims, the word “comprising” or “including” does not exclude other elements or steps, and the independent article “a” or “an” does not exclude a plurality. The mere fact that certain measures are recited in mutually different dependent claims does not indicate that a combination of these measures cannot be used to advantage. Any reference symbols in the claims should not be construed as limiting the scope.

It will be appreciated by those skilled in the art that the present disclosure can be embodied in other specific forms without departing from the spirit or essential characteristics thereof. The presently disclosed exemplary embodiments are therefore considered in all respects to be illustrative and not restricted. The scope of the disclosure is indicated by the appended claims rather than the foregoing description and all changes that come within the meaning and range and equivalence thereof are intended to be embraced therein.

### LIST OF REFERENCE SYMBOLS

100 magnetic actuator unit
101 coil
102 core
103 core element
104 flank
105 flank
106 movable plate
108 second attachment element
110 first attachment element
111 screw(s)
112 leg part
113 leg part
114 base parts
115 flange part
120 axis
122 permanent magnet
130 fixing points
261 groove
262 groove
281 section of coil
282 section of coil
500 circuit breaker arrangement
521 contact
522 contact
spring

What is claimed is:

1. A magnetic actuator unit for a circuit breaker arrangement, the magnetic actuator unit comprising:
a coil;
a core for accommodating the coil, the core having permanent magnets, flanks, and a core element which is arranged between the permanent magnets and the flanks of the core;
a movable plate configured to be attracted by the core due to a magnetic field generated by the permanent magnets and the coil, the movable plate being configured to actuate the circuit breaker arrangement when being attracted by the core; and
one or more first attachment elements configured to attach the magnetic actuator unit to a member of the circuit breaker arrangement,
wherein the one or more first attachment elements are attached to the flanks and not to the core element of the core.

2. The magnetic actuator according to claim 1, comprising:
a fixing arrangement configured to fix the first attachment element to the flanks.

3. The magnetic actuator according to claim 2,
wherein the fixing arrangement comprises at least one screw.

4. The magnetic actuator according to claim 1, wherein the first attachment element is U-shaped and attached to the flanks at leg parts of the U-shaped first attachment element.

5. The magnetic actuator according to claim 1, wherein the first attachment element is U-shaped and attached to the member of the circuit breaker arrangement at a base part connecting leg parts of the U-shaped first attachment element.

6. The magnetic actuator according to claim 5, wherein the base part comprises a flange part extending away from the coil in a direction orthogonal to the base part.

7. The magnetic actuator according to claim 1,
wherein the first attachment element is made of a plate-like material.

8. The magnetic actuator according to claim 1, comprising:
one or more second attachments element attached to the flanks of the core for stabilizing the core;
wherein the second attachment element is non-magnetic to avoid a magnetic short circuit for the permanent magnets.

9. The magnetic actuator according to claim 8,
wherein the second attachment element comprises stainless steel.

10. A circuit breaker arrangement comprising:
at least one magnetic actuator unit according to claim 1;
a first electrical contact; and
a second electrical contact,
wherein the magnetic actuator unit is mechanically connected to the first and second electrical contacts, such that the movable plate is configured to actuate the circuit breaker arrangement by connecting or disconnecting the first and second contacts when moving.

11. The magnetic actuator according to claim 2, wherein the first attachment element is U-shaped and attached to the flanks at leg parts of the U-shaped first attachment element.

12. The magnetic actuator according to claim 11,
wherein the U-shaped first attachment element is attached to the member of the circuit breaker arrangement at a base part connecting the leg parts of the U-shaped first attachment element.

13. The magnetic actuator according to claim 12,
wherein the base part comprises a flange part extending away from the coil in a direction orthogonal to the base part.

14. The magnetic actuator according to claim 12, comprising:
one or more second attachments element attached to the flanks of the core for stabilizing the core;
wherein the second attachment element is non-magnetic to avoid a magnetic short circuit for the permanent magnets.

15. The magnetic actuator according to claim 14,
wherein the second attachment element comprises stainless steel.

16. A circuit breaker arrangement comprising:
at least one magnetic actuator unit according to claim 14;
a first electrical contact; and
a second electrical contact,
wherein the magnetic actuator unit is mechanically connected to the first and second electrical contacts, such that the movable plate is configured to actuate the circuit breaker arrangement by connecting or disconnecting the first and second contacts when moving.

17. The magnetic actuator according to claim 4,
wherein the U-shaped first attachment element is attached to the member of the circuit breaker arrangement at a base part connecting the leg parts of the U-shaped first attachment element.

18. The magnetic actuator according to claim 17,
wherein the base part comprises a flange part extending away from the coil in a direction orthogonal to the base part.

19. The magnetic actuator according to claim 17, comprising:
one or more second attachments element attached to the flanks of the core for stabilizing the core;
wherein the second attachment element is non-magnetic to avoid a magnetic short circuit for the permanent magnets.

20. The magnetic actuator according to claim 19,
wherein the second attachment element comprises stainless steel.

21. A circuit breaker arrangement comprising:
at least one magnetic actuator unit according to claim 19;
a first electrical contact; and
a second electrical contact,
wherein the magnetic actuator unit is mechanically connected to the first and second electrical contacts, such that the movable plate is configured to actuate the circuit breaker arrangement by connecting or disconnecting the first and second contacts when moving.

22. A method of assembling a magnetic actuator unit for a circuit breaker arrangement, the method comprising:
putting a coil into a groove of a core of the magnetic actuator unit, such that a section of the coil is accommodated in the groove;
attaching a second attachment element to flanks of the core; and
attaching a first attachment element for attaching the magnetic actuator unit to a member of the circuit breaker arrangement to the flanks of the core.
